(19) United States
(12) Patent Application Publication
(10) Pub. No.: US 2006/0046704 A1
(43) Pub. Date: Mar. 2, 2006

(54) Mobile communication terminal

(75) Inventors: Toshiro Hori, Tokyo (JP); Seijiro Doi, Hyogo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: MITSUBISHI DENKI KABUSHIKI KAISHA, Tokyo (JP)

(21) Appl. No.: 11/007,288

(22) Filed: Dec. 9, 2004

(30) Foreign Application Priority Data
Aug. 30, 2004 (JP) 2004-250646

(51) Int. Cl. H04Q 7/20

(52) U.S. Cl. 455/418; 455/575.1

(57) ABSTRACT

A mobile communication terminal includes a radio unit (6) having a wireless-communications function, an input/output unit (1) for receiving disable setting information about a setting which disables the wireless-communications function of the radio unit (6), an internal memory (3) in which information indicating an operation mode of the radio unit (6) is stored, a UI processing unit (2) for storing information indicating a disable mode in which the wireless-communications function of the radio unit (6) is disabled in the internal memory (3) when the disable setting information is inputted to the input/output unit (1), and an external input/output device control unit (5) that controls power supply to the radio unit (6) when the mobile communication terminal is powered on, and that does not supply electric power to the radio unit (6) when the information indicating the disable mode is stored in the internal memory (3).

### BACKGROUND OF THE INVENTION

1. Field of the Invention

The present invention relates to a mobile communication terminal that can enable or disable its wireless-communications function when the mobile communication terminal is started.

2. Description of Related Art

According to the Aviation Act of Japan, it is stipulated that users must not always effect the operation of mobile phones and other electronic equipment that enter “a state of emitting electric waves” under operating conditions while users must not effect the operation of mobile phones and other electronic equipment that enter “a state of not emitting any electric waves” under operating conditions only during takeoff or landing.

There have been provided prior art technologies which are disclosed in the following patent references 1 to 3 to the requests of the Aviation Act of Japan. In accordance with the prior art technology disclosed in patent reference 1, a detection mechanism for detecting the atmospheric pressure is disposed in a mobile communication terminal, and, when detecting a low pressure such as the atmospheric pressure of an airplane which is taking off, the detection mechanism mechanically locks the supply of electric power to the main body of the mobile communication terminal so that the main body of the mobile communication terminal is not powered on.

In addition, in accordance with the prior art technology disclosed in patent reference 2, a transmission restriction/release mechanism is disposed in an airplane, a hospital, or the like in which precision electronic equipment which is susceptible to electric waves is installed, and, when detecting a magnetic field generated by the transmission restriction/release mechanism, a wireless-communications terminal suspends wireless communications with a normal electric field strength and then switches to wireless communications with a feeble electric field strength which has no influence on the precision electronic equipment.

In accordance with the prior art technology disclosed in patent reference 3, a wireless-communications terminal receives an electric wave emitted from a radio base apparatus which provides notification of restrictions on radio communications for preventing electromagnetic interference in advance, and then turns off the power supply automatically or stops transmission automatically when determining that it has received the notification of restrictions on radio communications.
[Patent reference 1] JP,6-188826,A
[Patent reference 2] JP,10-243462,A
[Patent reference 3] JP,11-308675,A

A problem with prior art mobile communication terminals is that they cannot be made to operate in a state in which their wireless-communications functions are completely disabled after the power supply of the main body has been powered off. That is, in accordance with the technologies disclosed in patent references 1 to 3, the mobile communication terminal is controlled so that its wireless communications switch from an enable state to a disable state when the user carrying the mobile communication terminal is staying in a place where wireless communications are restricted, and the user cannot effect the operation of the mobile communication terminal with this terminal being in a state in which the wireless-communications function is disabled.

If the user can effect the operation of the mobile communication terminal with this terminal being in a state in which the wireless-communications function is completely disabled at times other than takeoff and landing after turning off the power supply of the main body of the mobile communication terminal before takeoff or landing, the mobile communication terminal can be assumed to be electronic equipment that enter “a state of not emitting any electric waves” under operating conditions according to the Aviation Act of Japan. If so, the user can use any other function of the mobile communication terminal other than the wireless-communications function, for example, a PDA function, a music player function, a camera function, or the like, while the user is staying in an airplane.

However, in accordance with the prior art technologies, the mobile communication terminal is controlled so that the power supply of the mobile communication terminal is always stopped even at times other than takeoff and landing, and its wireless-communications function is not disabled completely and wireless communications with a feeble electric field strength can be carried out. Therefore, the mobile communication terminal cannot be assumed to be electronic equipment that enter “a state of not emitting any electric waves” under operating conditions, and there are cases where the user cannot use any other function of the mobile communication terminal other than the wireless-communications function while the user is staying in an airplane.

### SUMMARY OF THE INVENTION

The present invention is made in order to solve the above-mentioned problems, and it is therefore an object of the present invention to provide a mobile communication terminal that can be operated with its wireless-communications function being disabled through a simple operation.

In accordance with the present invention, there is provided a mobile communication terminal including: a wireless communication unit having a wireless-communications function; a setting input unit for receiving setting information about a setting which disables the wireless-communications function of the wireless communication unit; a storage unit in which information indicating an operation mode of the wireless communication unit is stored; a processing unit for storing information indicating a disable mode in which the wireless-communications function of the wireless communication unit is disabled into the storage unit when the setting information about the setting which disables the wireless-communications function of the wireless communication unit is inputted to the mobile communication terminal via the setting input unit; and a disable control unit for controlling the wireless-communications function of the wireless communication unit so that the wireless-communications function does not work if the information indicating the disable mode is stored in the storage unit when the mobile communication terminal is powered on.

Therefore, the user can start the mobile communication terminal with the wireless-communications function being placed in the disable mode.

Further objects and advantages of the present invention will be apparent from the following description of the preferred embodiments of the invention as illustrated in the accompanying drawings.

### BRIEF DESCRIPTION OF THE DRAWINGS

FIG. 1 is a diagram showing the structure of a mobile communication terminal in accordance with the present invention;

FIG. 2 is a flow chart showing the operation of the mobile communication terminal in accordance with embodiment 1.

FIG. 2 is a flow chart showing the operation of a mobile communication terminal in accordance with embodiment 2;

FIG. 4 is a flow chart showing the operation of a mobile communication terminal in accordance with embodiment 3; and

FIG. 5 is a flow chart showing the operation of a mobile communication terminal in accordance with embodiment 4.

### DETAILED DESCRIPTION OF THE PREFERRED EMBODIMENTS

### Embodiment 1

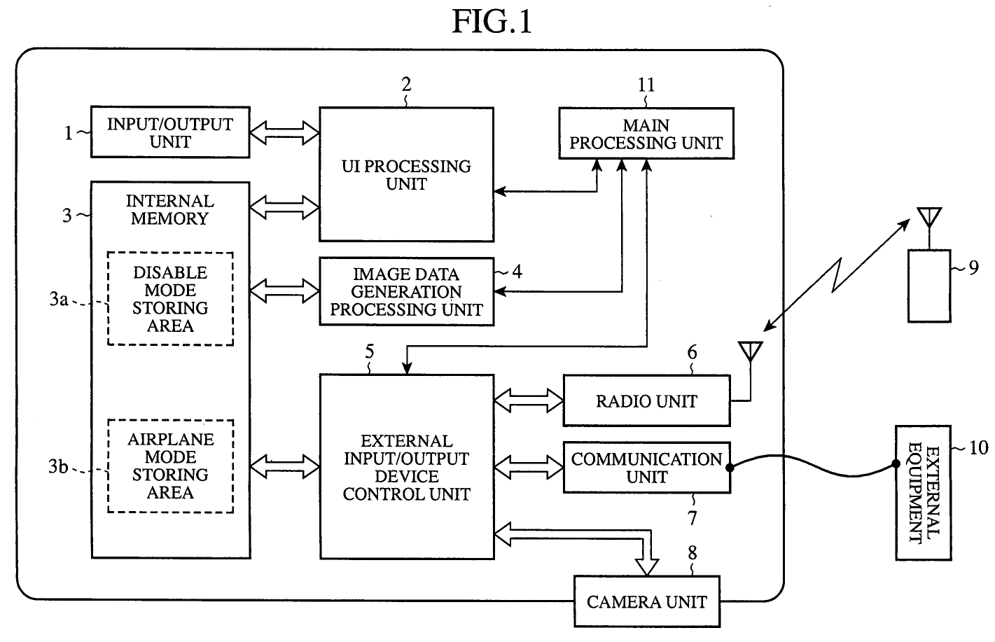

FIG. 1 is a diagram showing the structure of a mobile communication terminal in accordance with the present invention. This mobile communication terminal is provided with an input/output unit 1, a UI (User Interface) processing unit 2, an internal memory 3, an image data generation processing unit 4, an external input/output device control unit 5, a radio unit 6, a communication unit 7, and a main processing unit 11. The input/output unit (i.e., a setting input unit) 1 is a component which provides an interface between the mobile communication terminal and the user, and, is, for example, a set of key buttons, LCD, etc. which are standardly mounted on a mobile phone or PDA. The UI processing unit (i.e., a processing unit) 2 sets setting information about either a wireless-communications function disable mode in which a wireless-communications function of the radio unit 6 is disabled or an airplane mode to the internal memory 3 based on input information about mode setting from outside the mobile communication terminal. The main processing unit 11 controls the operations of the UI processing unit 2, the image data generation processing unit 4, and the external input/output device control unit 5.

The internal memory (i.e., a storage unit) 3 is a storage device disposed within the mobile communication terminal, and stores the setting information about the wireless-communications function disable mode and the setting information about the airplane mode. The mode setting information about the wireless-communications function disable mode is stored in a wireless-communications function disable mode area 3a of the internal memory. The mode setting information about the airplane mode is stored in an airplane mode area 3b of the internal memory. The image data generation processing unit 4 generates an image file including image data about an image picked up by a camera unit 8 and stores it in the internal memory 3.

The external input/output device control unit (i.e., a disable control unit) 5 controls wireless-communications between the radio unit 6 and an external radio device, such as a base station 9, data-communications between the communication unit (i.e., the setting input unit) 7 and external equipment 10, and the image pickup processing by the camera unit (i.e., the setting input unit) 8, and also controls supply of electric power to the radio unit 6 based on the mode setting information stored in the internal memory 3.

The radio unit (i.e., a wireless communication unit) 6 carries out wireless communications with the external radio device, such as the base station 9. The communication unit 7 carries out either communications via a communication line such as a USB cable, or wireless communications via a cordless interface using infrared radiations or the like, with the external equipment 10. An apparatus, such as a printer or a personal computer, which can carry out either communications via a communication line such as a USB cable, or wireless communications via a cordless interface using infrared radiations or the like, with the mobile communication terminal according to this embodiment is used as the external equipment 10. The camera unit 8 for acquiring image data can be disposed in the mobile communication terminal, or can be attached to the mobile communication terminal from outside the mobile communication terminal.

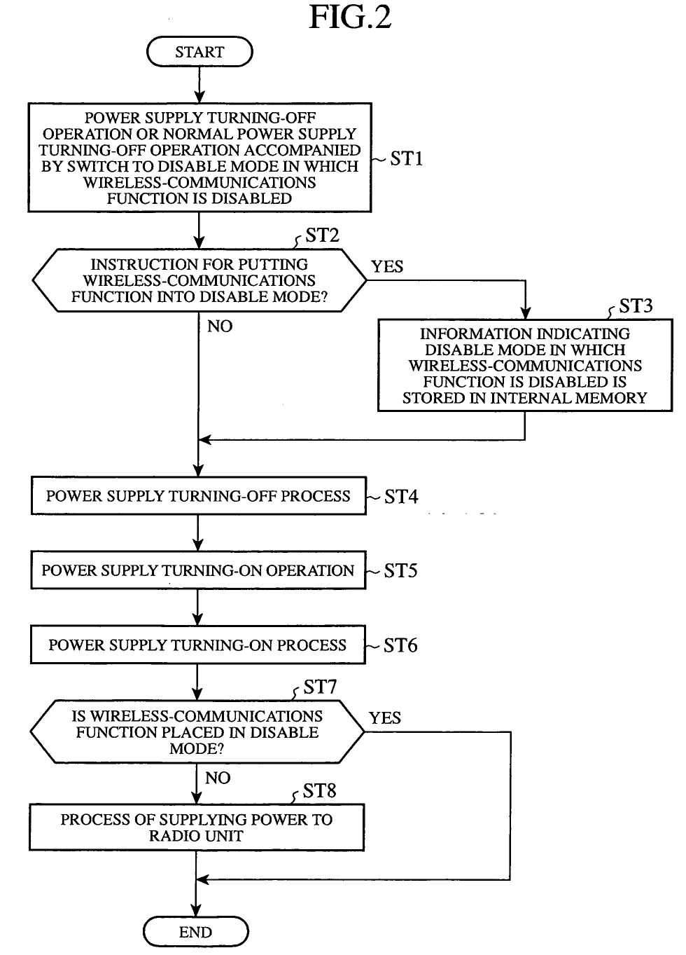

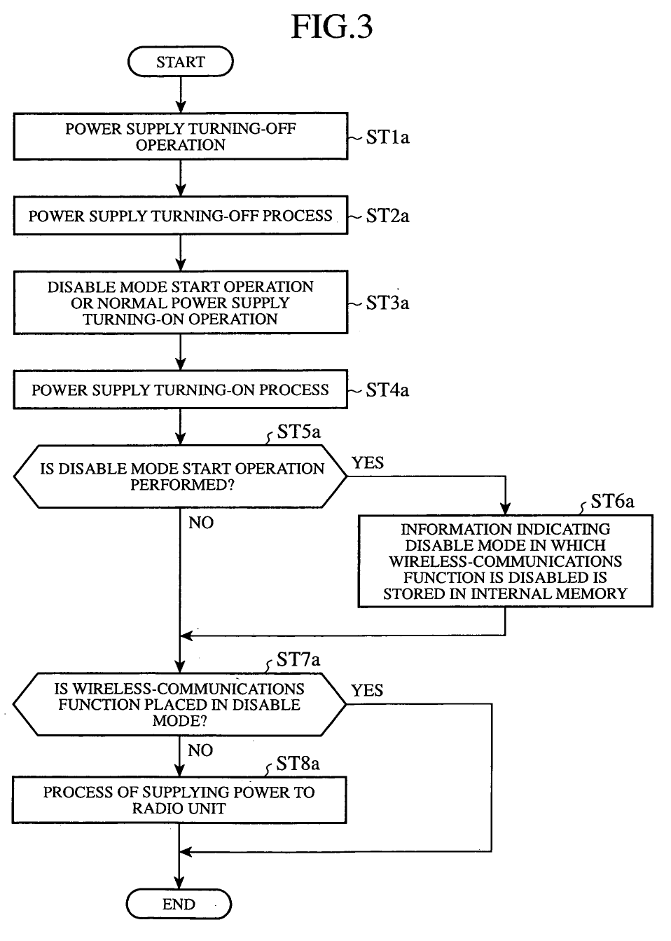

Next, the operation of the mobile communication terminal in accordance with embodiment 1 of the present invention will be explained. FIG. 2 is a flow chart showing the operation of the mobile communication terminal in accordance with embodiment 1, and shows a process of switching off a power supply for supplying electric power to a main body of the mobile communication terminal and simultaneously disabling the wireless-communications function of the radio unit.

First, the user performs an operation of switching off the mobile communication terminal according to this embodiment. In order to simply switch off the power supply of the mobile communication terminal, the user pushes down a power supply key button for switching on and off the power supply of the main body of the mobile communication terminal. On the other hand, when the user desires to disable the wireless-communications function of the radio unit at the same time that the user switches off the power supply, the user performs a specific operation which will be mentioned later (in step ST1). For example, the user who carries the mobile communication terminal according to this embodiment can perform this operation before an airplane which the user gets aboard takes off the ground, can turn off the power supply of the mobile communication terminal, and can start the mobile communication terminal with the wireless-communications function of the radio unit being in the disable state only by switching on the power supply of the main body of the mobile communication terminal after takeoff.

For example, each of the following operations (1) to (5) can be the operation of disabling the wireless-communications function at the same time that the power supply of the main body of the mobile communication terminal is turned off.

(1) Key Button Operation

A trigger for starting a series of processes of putting the wireless-communications function of the radio unit into the disable mode in which the wireless-communications function is disabled so as to place the wireless-communications function in the disable mode even after the power supply will be switched on, and turning of f the power supply of the main body of the mobile communication terminal is associated with a specific operation to be performed on a specific key button included in the key buttons which constitute the input/output unit 1.

For example, an airplane mode key button can be included in the key buttons which constitute the input/output unit 1, and can be so constructed as to generate a trigger signal for starting the above-mentioned series of processes when the user pushes down this airplane mode key button during a long period of time. As an alternative, when the user simultaneously pushes down both the power supply key button and the airplane mode key, a trigger signal for starting the above-mentioned series of processes can be generated.

(2) Bar Code Recognition

Acquisition of data about recognition of a predetermined bar code indicating setting of the wireless-communications function disable mode is defined as a trigger for starting a series of processes of putting the wireless-communications function of the radio-unit into the disable mode in which the wireless-communications function is disabled so as to place the wireless-communications function in the disable mode even after the power supply will be switched on, and turning off the power supply of the main body of the mobile communication terminal.

In this case, a bar code reader is disposed as the external equipment 10, and the predetermined bar code is recognized by this bar code reader. The mobile communication terminal then receives data about the recognition of the predetermined bar code from the external equipment 10 via a cable or radio communication channel by using the communication unit 7. As a result, the UI processing unit 2 receives the above-mentioned recognition data via the external input/output device control unit 5, and then starts the above-mentioned series of processes, as will be mentioned later. For example, a bar code showing boarding to airplanes is stuck, as the predetermined bar code, to a predetermined position of a boarding entrance to an airplane, or a TV monitor which displays the predetermined bar code showing setting of the wireless-communications function disable mode can be disposed at a predetermined position of a boarding entrance to an airplane.

(3) Camera Image Recognition

Acquisition of image data about an image in which a predetermined digital-watermarking code indicating setting of wireless-communications function disable mode is embedded is defined as a trigger for starting a series of processes of putting the wireless-communications function of the radio unit into the disable mode in which the wireless-communications function is disabled so as to place the wireless-communications function in the disable mode even-after the power supply will be switched on, and turning off the power supply of the main body of the mobile communication-terminal.

In this case, the mobile communication terminal picks up the above-mentioned image using the camera unit 8, inputs image data about this image into the UI processing unit 2 via the external input/output device control unit 5, and starts the above-mentioned series of processes, as will be mentioned later. For example, a specific display or symbol mark showing the words “Turn off your mobile phone or the like at the time of boarding”, in which a digital-watermarking code indicating setting of the wireless-communications function disable mode is embedded, is disposed at a boarding entrance or the like of an airplane. When picking up the specific display or symbol mark using the camera unit 8, the mobile communication terminal starts the above-mentioned series of processes.

(4) Detection of Magnetic Signal

Acquisition of a predetermined magnetic signal indicating setting of the wireless-communications function disable mode is defined as a trigger for starting a series of processes of putting the wireless-communications function of the radio unit into the disable mode in which the wireless-communications function is disabled so as to place the wireless-communications function in the disable mode even after the power supply will be switched on, and turning off the power supply of the main body of the mobile communication terminal.

In this case, a magnetic generator for sending out the predetermined magnetic signal is disposed as the external equipment 10, and the communication unit 7 detects a magnetic field associated with the above-mentioned magnetic signal generated by the magnetic generator. The mobile communication terminal inputs the above-mentioned magnetic signal from the communication unit 7 to the UI processing unit 2 via the external input/output device control unit 5, and then starts the above-mentioned series of processes, as will be mentioned later. For example, the above-mentioned magnetic field generator can be disposed in a boarding entrance to an airplane, or the like.

(5) Infrared Ray Communications or Short-Distance Wireless Communications

Acquisition of a predetermined communication signal indicating setting of the wireless-communications function disable mode is defined as a trigger for starting a series of processes of putting the wireless-communications function of the radio unit into the disable mode in which the wireless-communications function is disabled so as to place the wireless-communications function in the disable mode even after the power supply will be switched on, and turning off the power supply of the main body of the mobile communication terminal.

In this case, an infrared-ray communication device or a short-distance wireless communication device for sending out the predetermined communication signal is provided as the external equipment 10, and the communication unit 7 receives the above-mentioned communication signal sent out by the infrared-ray communication device or the short-distance wireless communication device. The mobile communication terminal inputs the above-mentioned magnetic signal from the communication unit 7 into the UI processing unit 2 via the external input/output device control unit 5, and then starts the above-mentioned series of processes, as will be mentioned later. For example, either the infrared-ray (Ir) communication device or the short-distance wireless communication (e.g., Felica (registered trademark) or BlueTooth (registered trademark) communication) device can be disposed in a boarding entrance to an airplane, or the like. When any one of the above-mentioned operations is performed, the UI processing unit 2 of the mobile communication terminal according to this embodiment determines whether the mobile communication terminal has received an instruction for putting the wireless-communications function into the disable mode (in step ST2).

This determination processing will be explained as to each of the above-mentioned operations (1) to (5).

(1) Key Button Operation

When the user performs a specific operation on a specific key button included in the key buttons which constitute the input/output unit 1, an input signal associated with this specific operation is inputted from the input/output unit 1 to the UI processing unit 2. A condition, such as a duration of time that the input signal caused by a pushdown of a specific key button placed at a specific position should be being input to the UI processing unit 2, is set in advance to the UI processing unit 2, and the UI processing unit 2 determines whether the pushdown of the specific key button indicates an instruction for putting the wireless-communications function into the disable mode by determining whether the input signal satisfies this condition.

For example, in a case where the predetermined airplane mode key button needs to be pushed down for a certain long period of time in order to put the wireless-communications function into the disable mode at the same time that the mobile communication terminal is powered off, the duration of time that an input signal caused by a pushdown of the airplane mode key button placed at a specific key button position should be being input to the UI processing unit 2 is set in advance to the UI processing unit 2 as a condition for setting of the wireless-communications function disable mode. As a result, the UI processing unit 2 determines whether or not it has received an instruction for putting the wireless-communications function into the disable mode by determining whether the input signal from the input/output unit 1, which is caused by the pushdown of the airplane mode key button, satisfies the above-mentioned condition for the mode setting.

In a case where the power supply key button and the airplane mode key button need to be simultaneously pushed down in order to put the wireless-communications function into the disable mode at the same time that the mobile communication terminal is powered off, the UI processing unit 2 determines whether or not it has received an instruction for putting the wireless-communications function into the disable mode by determining whether it has received input signals caused by a pushdown of both the airplane mode key button and the power supply key button respectively placed at specific positions of the key button array.

(2) Bar Code Recognition

When a bar code reader disposed as the external equipment 10 recognizes the predetermined bar code indicating setting of the wireless-communications function disable mode, the bar code reader transmits recognition data about the recognition of the predetermined bar code to the communication unit 7 of the mobile communication terminal via a cable or radio communication line. When the above-mentioned recognition data is inputted from this communication unit 7 to the UI processing unit 2 via the external input/output device control unit 5, the UI processing unit 2 determines that the mobile communication terminal has received an instruction for putting the wireless-communications function into the disable mode.

For example, a bar code showing boarding to airplanes is stuck, as the predetermined bar code, to a predetermined position of a boarding entrance to an airplane, or a TV monitor which displays the predetermined bar code indicating setting of the wireless-communications function disable mode can be disposed at a predetermined position of a boarding entrance to an airplane, so that the bar code reader can recognize the bar code. The communication unit 7 can thus receive the recognition data about the recognition of the bar code from this bar code reader via a cable or radio communication line. When receiving the recognition data from the communication unit 7 via the external input/output device control unit 5, the UI processing unit 2 determines that the mobile communication terminal has received an instruction for putting the wireless-communications function into the disable mode.

(3) Camera Image Recognition

When picking up an image in which a predetermined digital-watermarking code indicating setting of the wireless-communications function disable mode is embedded, the camera unit 8 delivers image data about the image to the UI processing unit 2 via the external input/output device control unit 5. The digital-watermarking code indicating setting of the wireless-communications function disable mode is set in advance to the UI processing unit 2, and the UI processing unit 2 determines whether or not it has received an instruction for putting the wireless-communications function into the disable mode by determining whether the code included in the image data inputted thereto from the camera unit 8 agrees with the code set in advance thereto.

(4) Detection of Magnetic Signal

The communication unit 7 detects-a magnetic field caused by a predetermined magnetic signal indicating setting of the wireless-communications function disable mode sent out by a magnetic generator disposed as the external equipment 10. The UI processing unit 2 determines whether or not it has received an instruction for putting the wireless-communications function into the disable mode by determining whether it has received the above-mentioned magnetic signal from the communication units 7 via the external input/output device control unit 5.

(5) Infrared Ray Communications and Short-Distance Wireless Communications

The communication unit 7 receives a predetermined transmission signal indicating setting of the wireless-communications function disable mode, which is transmitted thereto from either an infrared-ray communications unit or a short-distance wireless-communications unit which is disposed as the external equipment 10. The UI processing unit 2 determines whether or not it has received an instruction for putting the wireless-communications function into the disable mode by determining whether it has received the above-mentioned transmission signal from the communication unit 7 via the external input/output device control unit 5.

When, in step ST2, determining that the mobile communication terminal has received an instruction for putting the wireless-communications function into the disable mode, the UI processing unit 2 stores information indicating the wireless-communications function disable mode in the disable mode storing area 3a of the internal memory 3 (in step ST3). For example, a flag indicating whether or not the radio unit of the mobile communication terminal is placed in the wireless-communications function disable mode is stored in the disable mode storing area 3a, and the UI processing unit 2 sets a digital value to the flag indicating that the wireless-communications function is put into the disable mode when determining that the mobile communication terminal has received an instruction for putting the wireless-communications function into the disable mode.

When, in step ST2, determining that the mobile communication terminal has not received an instruction for disabling the wireless-communications function, or when completing the process of step ST3, the UI processing unit 2 immediately turns off the power supply of the main body of the mobile communication terminal by carrying out the operation of simply turning off the mobile communication terminal in step ST1 and any one of the above-mentioned operations (1) to (5) (in step ST4).

After that, when the user pushes down the power supply key button so as to perform a normal power supply turning-on operation on the main body of the mobile communication terminal (in step ST5), electric power is supplied to the internal components of the mobile communication terminal other than the radio unit 6 (in step ST6). Immediately after the mobile communication terminal is started up, the external input/output device control unit 5 reads the contents of the disable mode storing area 3a of the internal memory 3 and determines whether or not the wireless-communications function of the radio unit 6 is placed in the disable mode (in step ST7). For example, the external input/output device control unit 5 determines whether the flag stored in the disable mode storing area 3a has a digital value indicating the disable mode.

When any one of the above-mentioned specific operations for putting the wireless-communications function into the disable mode was performed in step ST1, or when the mobile communication terminal was powered off the last time with the wireless-communications function being placed in the disable mode, the external input/output device control unit 5, in step ST7, determines that the wireless-communications function is placed in the disable mode. At this time, the external input/output device control unit 5 does not supply electric power to the radio unit 6. As a result, the user can start the main body of the mobile communication terminal with the wireless-communications function being placed in the disable mode only by pushing down the power supply key button so as to make the mobile communication terminal carry out normal turning on of the main body of the mobile communication terminal.

On the other hand, when the wireless-communications function is not placed in the disable mode, the external input/output device control unit 5 carries out a process of supplying electric power to the radio unit 6 (in step ST8). The external input/output device control unit 5 can determine that the wireless-communications function is not placed in the disable mode when a simple turning-off operation was performed in step ST1 and the disable mode was not established the last time according to, for example, the user's operation of putting the wireless-communications function into an enable mode under guidance provided on a function setting menu screen.

As mentioned above, in accordance with embodiment 1. the mobile communication terminal includes the radio unit 6 having a wireless-communications function, the setting input unit for receiving disable setting information about a setting which puts the wireless-communications function of the radio unit 6 into the disable mode, such as the input/output unit 1, the communication unit 7, and the camera unit 8, the internal memory 3 in which information indicating an operation mode of the radio unit 6 is stored, the UI processing unit 2 for storing information indicating the disable mode in which the wireless-communications function of the radio unit 6 is disabled in the internal memory 3 when the disable setting information about the setting which puts the wireless-communications function of the radio unit 6 into the disable mode is inputted to the mobile communication terminal, and the external input/output device control unit 5 that controls supply of electric power to the radio unit 6 when the mobile communication terminal is powered on, and that does not supply electric power to the radio unit 6 when the information indicating the disable mode is stored in the internal memory 3. Therefore, the user can switch off the power supply of the main body of the mobile communication terminal with the wireless-communications function of the radio unit being placed in the disable mode through a simple operation using a key operation, a bar code recognition, a camera image recognition, a detection of magnetism, or infrared ray or short-distance wireless communications. Furthermore, the user can start the main body of the mobile communication terminal with the wireless-communications function being placed in the disable mode only by performing a normal power supply turning-on operation such as a pushdown of the power supply key button.

### Embodiment 2

A mobile communication terminal according to this embodiment 2 has the same structure as that according to above-mentioned embodiment as shown in FIG. 1, and puts the wireless-communications function of a radio unit into a disable mode at the same time that the mobile communication terminal is made to switch on a power supply of a main body of the mobile communication terminal.

Next, the operation of the mobile communication terminal in accordance with embodiment 2 of the present invention will be explained. FIG. 3 is a flow chart showing the operation of the mobile communication terminal according to embodiment 2, and shows a process of disabling the wireless-communications function of the radio unit 6 at the same time the mobile communication terminal is made to switch on the main body of the mobile communication terminal.

First, a user pushes down a power supply key button of an input/output unit 1 in order to perform an operation of turning off the main body of the mobile communication terminal (in step ST1a). The UI processing unit 2 then stops a supply of electric power to each component of the main body of the mobile communication terminal (in step ST2a).

After that, the user performs an operation of turning on the mobile communication terminal according to this embodiment. When the user simply desires to turn on the mobile communication terminal, he or she pushes down the power supply key button of the main body of the mobile communication terminal. On the other hand, when the user desires to disable the wireless-communications function of the radio unit 6 at the same time that he or she turns on the mobile communication terminal, he or she performs a disable mode starting operation of putting the wireless-communications function of the radio unit 6 into a disable mode in which the wireless-communications function is disabled at the same time that the mobile communication terminal is powered on (in step ST3a). In this case, the mobile communication terminal receives information about a setting which disables the wireless-communications function of the radio unit 6 in synchronization with the user's operation. For example, a trigger for starting the series of processes of switching on mobile communication terminal and simultaneously putting the wireless-communications function into the disable mode is associated with a specific key button included in the key buttons which constitute the input/output unit 1.

Concretely, an airplane start mode key button can be included in the key buttons which constitute the input/output unit 1, and can be so set as to generate a trigger signal for starting the above-mentioned series of processes when the user pushes down this key button during a certain period of time. As an alternative, when the user simultaneously pushes down both the power supply key button and another specific key button, a trigger signal for starting the above-mentioned series of processes can be generated.

When the user performs either the disable mode starting operation of putting the wireless-communications function of the radio unit into the disable mode at the same time that the mobile communication terminal is powered on or a normal turning-on operation of turning on the mobile communication terminal through the input/output unit 1 in step ST3a, the UI processing unit 2 supplies electric power to the internal components of the mobile communication terminal other than the radio unit 6 (in step ST4a). The UI processing unit 2 then determines whether or not the operation performed in step ST3a is the disable mode starting operation of putting the wireless-communications function of the radio unit into the disable mode at the same time that the mobile communication terminal is powered on (in step ST5a).

When the user performs a specific operation on the specific key button included in the key buttons which constitute the input/output unit 1, the input/output unit 1 sends out an input signal corresponding to this operation performed by the user to the UI processing unit 2. A correspondence between an input signal generated by the user's pushdown of the specific key at a specific position of the key button array and the disable mode starting operation of putting the wireless-communications function of the radio unit into the disable mode at the same time that the mobile communication terminal is powered on is set in advance to the UI processing unit 2. The UI processing unit 2 determines whether or not the disable mode starting operation of putting the wireless-communications function of the radio unit into the disable mode at the same time that the mobile communication terminal is powered on has been performed by determining whether it has received the input signal when the mobile communication terminal is powered on.

For example, in a case where the predetermined airplane start mode key button needs to be pushed down in order to put the wireless-communications function into the disable mode at the same time that the mobile communication terminal is powered on, the reception of the input signal caused by pushdown of the airplane start mode key button placed at a specific position of the key button array should be input to the UI processing unit 2 is set in advance to the UI processing unit 2 as the disable mode starting operation of putting the wireless-communications function of the radio unit into the disable mode at the same time that the mobile communication terminal is powered on. The UI processing unit 2 can thus determine whether or not the user has performed the disable mode starting operation of putting the wireless-communications function of the radio unit into the disable mode at the same time that the mobile communication terminal is powered on by determining whether an input signal from the input/output unit 1, which is caused by the user's pushdown of a key button, agrees with the input signal associated with the disable mode starting operation.

In a case where the power supply key button and another specific key button need to be simultaneously pushed down in order to put the wireless-communications function into the disable mode at the same time that the mobile communication terminal is powered on, the UI processing unit 2 determines whether or not the user has performed the disable mode starting operation of putting the wireless-communications function of the radio unit into the disable mode at the same time that the mobile communication terminal is powered on by determining whether it has simultaneously received input signals from specific key positions where the power supply key button and the other specific key button are respectively placed in the key button array.

When determining that the user has performed the disable mode starting operation of putting the wireless-communications function of the radio unit into the disable mode at the same time that the mobile communication terminal is powered on, the UI processing unit 2 stores information indicating the wireless-communications function disable mode in a disable mode storing area 3a of the internal memory 3 (in step ST6a). For example, a flag indicating whether or not the wireless-communications function is placed in the disable mode is stored in the disable mode storing area 3a, and the UI processing unit 2 sets a digital value indicating that the wireless-communications function of the radio unit is placed in the disable mode to the flag when determining that the user has performed the disable mode starting operation.

When, in step ST5a, determining that the user has not performed the disable mode starting operation, or when completing the process of step ST6a, the UI processing unit 2 notifies the completion of the above-mentioned processing to an external input/output device control unit 5. The external input/output device control unit 5 then reads the contents of the disable mode storing area 3a of the internal memory 3 and determines whether or not the wireless-communications function is placed in the disable mode (in step ST7a). For example, the external input/output device control unit 5 determines whether the flag stored in the disable mode storing area 3a has a digital value indicating the disable mode so as to determine whether or not the wireless-communications function of the radio unit is placed in the disable mode.

When the user has performed the disable mode starting operation of putting the wireless-communications function of the radio unit into the disable mode at the same time that the mobile communication terminal is powered on or when the user has performed a normal turning-on operation after the mobile communication terminal was switched off with the wireless-communications function of the radio unit being put into an enable mode, in step ST3a, the external input/output device control unit 5, in step ST7a, determines that the wireless-communications function of the radio unit 6 is placed in the disable mode. At this time, the external input/output device control unit 5 does not supply electric power to the radio unit 6. The user can thus start the main body of the mobile communication terminal with the wireless-communications function being placed in the disable mode only by performing a simple operation, such as an operation of pushing down a specific key button.

On the other hand, when the wireless-communications function is not placed in the disable mode, the external input/output device control unit 5 supplies electric power to the radio unit 6 (in step ST8a). The external input/output device control unit 5 can determine that the wireless-communications function is not placed in the disable mode when a simple turning-on operation, such as an operation of pushing down the power supply key button, has been performed in step ST3a and the disable mode is not established according to, for example, the user's previous operation of putting the wireless-communications function into the enable mode by referring to a function setting menu screen before the mobile communication terminal was switched off the last time.

As mentioned above, in accordance with embodiment 2, the UI processing unit 2 sets information indicating the wireless-communications function disable mode to the internal memory 3 when receiving information about a setting which disables the wireless-communications function of the radio unit 6 which is caused by a user's specific operation of switching on the mobile communication terminal and simultaneously putting the wireless-communications function of the radio unit into the disable mode, and the external input/output device control unit 5 supplies no electric power to the radio unit 6 if the information indicating the disable mode is set to the internal memory 3 when any operation of switching on the mobile communication terminal is performed. Therefore, the user can start the main body of the mobile communication terminal with the wireless-communications function of the radio unit being put into the disable mode through a simple operation using a key operation.

### Embodiment 3

A mobile communication terminal according to this embodiment 3 has the same structure as that of above-mentioned embodiment 1 shown in FIG. 1, and is so constructed as to, when a mode setting has been made, disable the wireless-communications function of a radio unit at the same time that it will be powered on even though the wireless-communications function has been enabled before the mobile communication terminal is powered off.

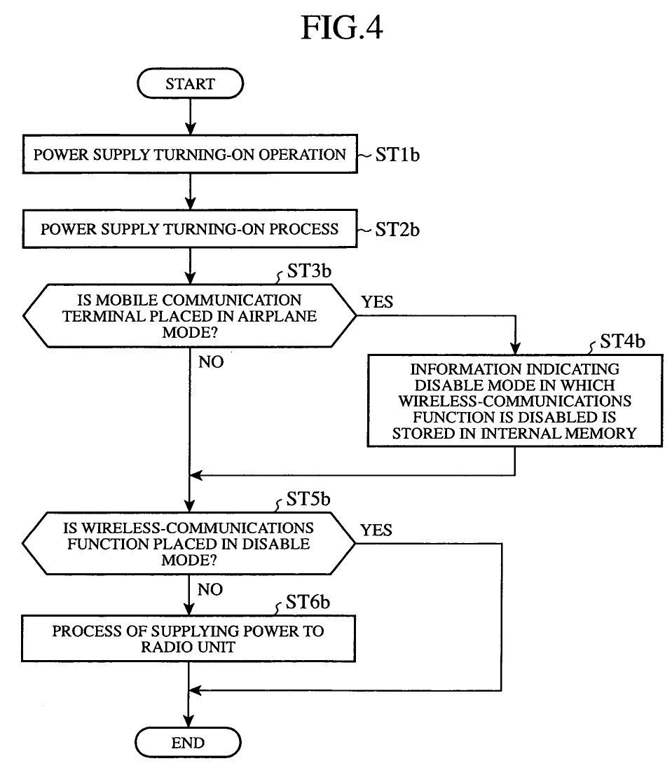

Next, the operation of the mobile communication terminal in accordance with embodiment 3 of the present invention will be explained. FIG. 4 is a flow chart showing the operation of the mobile communication terminal according to embodiment 3, and shows a process of starting the main body of the mobile communication terminal with the wireless-communications function being placed in a disable state in response to a user's normal turning-on operation of pushing down a power supply key button after the mobile communication terminal has been switched off with it being put into an airplane mode.

First, the user pushes down a power supply key button of an input/output unit 1 in order to perform a normal turning-on operation of turning on the main body of the mobile communication terminal (in step ST1b), a UI processing unit 2 then supplies electric power to components of the mobile communication terminal other than the radio unit 6 (in step ST2b).

The UI processing unit 2 then reads the contents of an airplane mode storing area 3b of an internal memory 3, and determines whether or not the mobile communication terminal is placed in the airplane mode (in step ST3b). The airplane mode according to this embodiment is a restriction mode in which the wireless-communications function of the radio unit 6 is not put into the disable mode immediately after the mobile communication terminal is put into the airplane mode, and the wireless-communications function is to be disabled when the mobile communication terminal will be powered on the next time.

In accordance with a method of putting the mobile communication terminal into the airplane mode, the UI processing unit 2 provides a GUI for mode setting for the user first. For example, the UI processing unit 2 displays a function setting menu screen on an LCD. When the user then performs an input operation associated with the airplane mode according to the above-mentioned function setting menu screen, the UI processing unit 2 determines that the mobile communication terminal is put into the airplane mode based on an input signal caused by the user's input operation and stores information indicating the airplane mode into the airplane mode storing area 3b. For example, a flag indicating whether or not the mobile communication terminal is put into the airplane mode is stored in the airplane mode storing area 3b, and the UI processing unit 2 sets a digital value indicating that the mobile communication terminal is put into the airplane mode to the flag when determining that the mobile communication terminal is put into the airplane mode.

When, in step ST3b, determining that the mobile communication terminal is put into the airplane mode, the UI processing unit 2 stores information indicating a disable mode in which the wireless-communications function is disabled to a disable mode storing area 3a of the internal memory 3 (in step ST4b). For example, a flag indicating whether or not the radio unit 6 of the mobile communication terminal is placed in the wireless-communications function disable mode is stored in the disable mode storing area 3a, and the UI processing unit 2 sets a digital value indicating that the wireless-communications function is put into the disable mode to the flag when determining that the wireless-communications function is put into the disable mode.

When, in step ST3b, determining that the mobile communication terminal is not put into the airplane mode, or when the process of step ST4b is completed, an external input/output device control unit 5 reads the contents of the disable mode storing area 3a of the internal memory 3 and then determines whether or not the wireless-communications function of the radio unit is put into the disable mode (in step ST5b). The external input/output device control unit 5 determines whether or-not the wireless-communications function of the radio unit is put into the disable mode by determining whether the flag stored in the disable mode storing region 3a has the digital value indicating the disable mode, for example.

When the mobile communication terminal, which was not placed in the airplane mode, was switched off the last time with the wireless-communications function of the radio unit being put into the disable mode, or when the information indicating the wireless-communications function disable mode is set to the disable mode storing area 3a in step ST4b, the external input/output device control unit 5, in step ST5b, determines that the wireless-communications function is put into the disable mode. At this time, the external input/output device control unit 5 supplies no electric power to the radio unit 6. Thus, the user's normal turning-on operation of pushing down the power supply key button can start the main body of the mobile communication terminal with the wireless-communications function of the radio unit being placed in the disable state. On the other hand, when the wireless-communications function is not put into the disable mode, that is, when the mobile communication terminal is not put into the airplane mode and the wireless-communications function of the radio unit is not put into the disable mode according to the user's previous operation of putting the wireless-communications function of the radio unit to the enable mode by referring to a function setting menu screen before the mobile communication terminal was switched off the last time, the external input/output device control unit 5 supplies electric power to the radio unit 6 (in step ST6b).

As mentioned above, in accordance with embodiment 3, the UI processing unit 2 sets information indicating the airplane mode to the internal memory 3 when receiving an instruction for putting the mobile communication terminal into the airplane mode which is a restriction mode in which the wireless-communications function of the radio unit 6 is to be disabled when the mobile communication terminal will be powered on, and sets information indicating the disable mode to the internal memory 3 if the mobile communication terminal is placed in the airplane mode when the mobile communication terminal is powered on, and the external input/output device control unit 5 supplies no electric power to the radio unit 6 if information indicating the disable mode is stored in the internal memory 3 when the mobile communication terminal is powered on. Even if the wireless-communications function of the radio unit has been enabled before the user turns off the mobile communication terminal, the user can start the mobile communication terminal with the wireless-communications function of the radio unit being put into the disable mode at the same that the mobile communication terminal is powered on by simply putting the mobile communication terminal into the airplane mode before turning off the mobile communication terminal.

### Embodiment 4

A mobile communication terminal according to this embodiment 4 has the same structure as that of above-mentioned embodiment 1 shown in FIG. 1, and is so constructed as to, when a mode setting has been made, receive a request to disable the wireless-communications function of a radio unit at the same time that the mobile communication terminal will be powered on, even though the wireless-communications function has been enabled before the mobile communication terminal is powered off, and to start the mobile communication terminal with the wireless-communications function of a radio unit being put into a disable mode in response to the request.

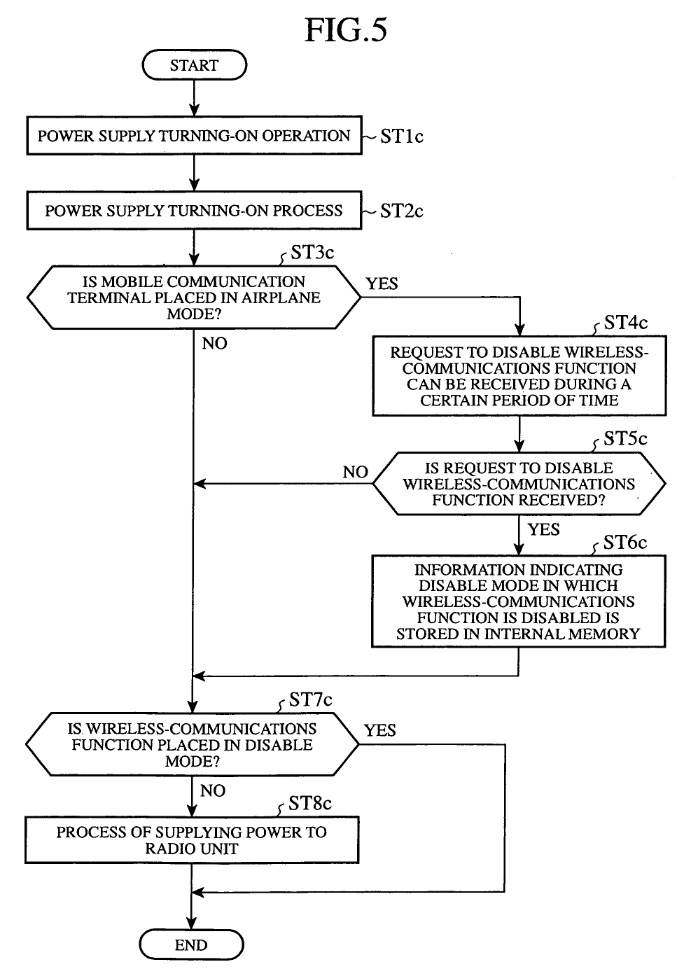

Next, the operation of the mobile communication terminal in accordance 4 with embodiment of the present invention will be explained. FIG. 5 is a flow chart showing the operation of the mobile communication terminal according to embodiment 4, and shows a process of putting the mobile communication terminal into an airplane mode in advance according to a user's operation, and starting the main body of the mobile communication terminal with the wireless-communications function of the radio unit being put into a disable mode in which the wireless-communications function is disabled in response to a request to disable the wireless-communications function according to the user's normal turning-on operation of pushing down a power supply key button after the mobile communication terminal will be powered on.

First, the user pushes down a power supply key button of an input/output unit 1 in order to perform a normal turning-on operation of turning on the main body of the mobile communication terminal (in step ST1c), a UI processing unit 2 then supplies electric power to components of the mobile communication terminal other than the radio unit 6 (in step ST2c).

The UI processing unit 2 then reads the contents of an airplane mode storing area 3b of an internal memory 3, and determines whether or not the mobile communication terminal is placed in the airplane mode (in step ST3c). The airplane mode according to this embodiment is a restriction mode in which the wireless-communications function of the radio unit 6 is not put into the disable mode immediately after the mobile communication terminal is put into the airplane mode, and the wireless-communications function is to be disabled when the mobile communication terminal will be powered on the next time.

In accordance with a method of putting the mobile communication terminal into the airplane mode, the UI processing unit 2 provides a GUI for mode setting for the user first. For example, the UI processing unit 2 displays a function setting menu screen on an LCD. When the user then performs an input operation associated with the airplane mode according to the above-mentioned function setting menu screen, the UI processing unit 2 determines that the mobile communication terminal is put into the airplane mode based on an input signal caused by the user's input operation and stores information indicating the airplane mode into the airplane mode storing area 3b. For example, a flag indicating whether or not the mobile communication terminal is put into the airplane mode is stored in the airplane mode storing area 3b, and the UI processing unit 2 sets a digital value indicating that the mobile communication terminal is put into the airplane mode to the flag when determining that the mobile communication terminal is put into the airplane mode, like that of above-mentioned embodiment 3.

When, in step ST3c, determining that the mobile communication terminal is placed in the airplane mode, the UI processing unit 2 receives a request to disable the wireless-communications function of the radio unit during a predetermined period of time from either the input/output unit 1 or a communication unit 7 or a camera unit 8 via an external input device control unit 5 (in step ST4c). Concretely, the request to disable the wireless-communications function of the radio unit is made by performing any one of the following operations (1) to (5) mentioned in above-mentioned embodiment 1.

(1) Key Button Operation

An issue of a request to disable the wireless-communications function is associated with a specific operation to be performed on a specific key button included in the key buttons which constitute the input/output unit 1.

For example, an airplane mode key button can be included in key buttons which constitute the input/output unit 1, and can be so constructed as to generate a trigger signal for starting the above-mentioned series of processes when the user pushes down this airplane mode key button during a long period of time.

As an alternative, the UI processing unit 2 can display the following sentence: “Do you desire to enter the wireless-communications functional disable mode? (y/n)” on an LCD, as a screen for receiving a request to disable the wireless-communications function, so that the user can make a request to disable the wireless-communications function by pushing down a key bottom according to these contents on the display.

(2) Bar Code Recognition

Acquisition of data about recognition of a predetermined bar code indicating setting of the wireless-communications function disable mode is defined as an issue of a request to disable the wireless-communications function. In this case, a bar code reader is disposed as external equipment 10, and the predetermined bar code is recognized by this bar code reader. The mobile communication terminal then receives data about the recognition of the predetermined bar code from the external equipment 10 via a cable or radio communication channel by using the communication unit 7. As a result, the UI processing unit 2 receives the above-mentioned recognition data via the external input/output device control unit 5.

(3) Camera Image Recognition

Acquisition of image data about an image in which a predetermined digital-watermarking code indicating setting of wireless-communications function disable mode is embedded is defined as an issue of a request to disable the wireless-communications function. In this case, the mobile communication terminal picks up the above-mentioned image using the camera unit 8 and inputs image data about this image into the UI processing unit 2 via the external input/output device control unit 5.

(4) Detection of Magnetic Signal

Acquisition of a predetermined magnetic signal indicating setting of the wireless-communications function disable mode is defined as an issue of a request to disable the wireless-communications function. In this case, a magnetic generator for sending out the predetermined magnetic signal is disposed as the external equipment 10, and the communication unit 7 detects a magnetic field associated with the above-mentioned magnetic signal generated by the magnetic generator. The mobile communication terminal inputs the above-mentioned magnetic signal from the communication unit 7 to the UI processing unit 2 via the external input/output device control unit 5.

(5) Infrared Ray Communications or Short-Distance Wireless Communications

Acquisition of a predetermined communication signal indicating setting of the wireless-communications function disable mode is defined as an issue of a request to disable the wireless-communications function. In this case, an infrared-ray communication device or a short-distance wireless communication device for sending out the predetermined communication signal is provided as the external equipment 10, and the communication unit 7 receives the above-mentioned communication signal sent out by the infrared-ray communication device or the short-distance wireless communication device. The mobile communication terminal inputs the above-mentioned magnetic signal from the communication unit 7 into the UI processing unit 2 via the external input/output device control unit 5.

When, in step ST4c, entering the reception state in which the mobile communication terminal receives a request to disable the wireless-communications function, every time the mobile communication terminal receives a signal from outside the mobile communication terminal via the input/output unit 1 or the external input device control unit 5 during the above-mentioned period of time, the UI processing unit 2 determines whether the received signal indicates a request to disable the wireless-communications function (in step ST5c). This determination processing is the same as that to be done when any of the operations (1) to (5) mentioned in embodiment 1 is performed. When the mobile communication terminal receives no input signal indicating a request to disable the wireless-communications function during the above-mentioned period of time, the UI processing unit 2 shifts to a process of step ST7c.

(1) Key Button Operation

When the user performs a specific operation on a specific key button included in the key buttons which constitute the input/output unit 1, an input signal associated with this specific operation is inputted from the input/output unit 1 to the UI processing unit 2. A condition, such as a duration of time that the input signal caused by a pushdown of a specific key button placed at a specific position should be being input to the UI processing unit 2, is set in advance to the UI processing unit 2, and the UI processing unit 2 determines whether the pushdown of the specific key button indicates a request to disable the wireless-communications function by determining whether the input signal satisfies this condition.

For example, in a case where the predetermined airplane mode key button needs to be pushed down for a certain long period of time in order for the user to make a request to disable the wireless-communications function after the mobile communication terminal is powered on, the duration of time that an input signal caused by a pushdown of the airplane mode key button placed at a specific key button position should be being input to the UI processing unit 2 is set in advance to the UI processing unit 2 as a condition for setting of the wireless-communications function disable mode. As a result, the UI processing unit 2 determines whether or not it has received a request to disable the wireless-communications function by determining whether the input signal from the input/output unit 1, which is caused by the pushdown of the airplane mode key button, satisfies the above-mentioned condition for the mode setting.

(2) Bar Code Recognition

When a bar code reader disposed as the external equipment 10 recognizes the predetermined bar code indicating setting of the wireless-communications function disable mode, the bar code reader transmits recognition data about the recognition of the predetermined bar code to the communication unit 7 of the mobile communication terminal via a cable or radio communication line. When the above-mentioned recognition data is inputted from this communication unit 7 to the UI processing unit 2 via the external input/output device control unit 5, the UI processing unit 2 determines that the mobile communication terminal has received a request to disable the wireless-communications function.

(3) Camera Image Recognition

When picking up an image in which a predetermined digital-watermarking code indicating setting of the wireless-communications function disable mode is embedded, the camera unit 8 delivers image data about the image to the UI processing unit 2 via the external input/output device control unit 5. The digital-watermarking code indicating setting of the wireless-communications function disable mode is set in advance to the UI processing unit 2, and the UI processing unit 2 determines whether or not it has received a request to disable the wireless-communications function by determining whether the code included in the image data inputted thereto from the camera unit 8 agrees with the code set in advance thereto.

(4) Detection of Magnetic Signal

The communication unit 7 detects a magnetic field caused by a predetermined magnetic signal indicating setting of the wireless-communications function disable mode sent out by a magnetic generator disposed as the-external equipment 10. The UI processing unit 2 determines whether or not it has received a request to disable the wireless-communications function by determining whether it has received the above-mentioned magnetic signal from the communication units 7 via the external input/output device control unit 5.

(5) Infrared Ray Communication and Short-Distance Wireless Communications

The communication unit 7 receives a predetermined transmission signal indicating setting of the wireless-communications function disable mode, which is transmitted thereto from either an infrared-ray communications unit or a short-distance wireless-communications unit which is disposed as the external equipment 10. The UI processing unit 2 determines whether or not it has received a request to disable the wireless-communications function by determining whether it has received the above-mentioned transmission signal from the communication unit 7 via the external input/output device control unit 5.

When, in step ST5c, determining that the mobile communication terminal has received a request to disable the wireless-communications function, the UI processing unit 2 stores information indicating the wireless-communications function disable mode in a disable mode storing area 3a of the internal memory 3 (in step ST6c). For example, a flag indicating whether or not the radio unit of the mobile communication terminal is placed in the wireless-communications function disable mode is stored in the disable mode storing area 3a, and the UI processing unit 2 sets a digital value to the flag indicating that the wireless-communications function is put into the disable mode when determining that the mobile communication terminal has received a request to disable the wireless-communications function.

When the UI processing unit 2, in step ST3c, determines that the mobile communication terminal is placed in the airplane mode, when the UI processing unit 2, in step ST5c, determines that it has not received any request to disable the wireless-communications function, or when the UI processing unit 2 completes the process of step ST6c, the external input/output device control unit 5 reads the contents of the disable mode storing area 3a of the internal memory 3 and determines whether or not the wireless-communications function of the radio unit 6 is placed in the disable mode (in step ST7c). For example, the external input/output device control unit 5 determines whether the flag stored in the disable mode storing area 3a has a digital value indicating the disable mode.

When the mobile communication terminal, which was not placed in the airplane mode, was switched off the last time with the wireless-communications function of the radio unit being put into the disable mode, or when the information indicating the wireless-communications function disable mode is set to the disable mode storing area 3a in step ST6c, the external input/output device control unit 5, in step ST7c, determines that the wireless-communications function is put into the disable mode. At this time, the external input/output device control unit 5 supplies no electric power to the radio unit 6. Thus, the user's normal turning-on operation of pushing down the power supply key button can start the main body of the mobile communication terminal with the wireless-communications function of the radio unit being placed in the disable state when the mobile communication terminal is placed in the airplane mode and has received a request to disable the wireless-communications function. On the other hand, when the wireless-communications function is not put into the disable mode, that is, when the mobile communication terminal is not put into the airplane mode and has not received any request to disable the wireless-communications function after the mobile communication terminal was powered on, and the wireless-communications function of the radio unit is not put into the disable mode according to the user's previous operation of putting the wireless-communications function of the radio unit to the enable mode by referring to a function setting menu screen before the mobile communication terminal was switched off the last time, the external input/output device control unit 5 supplies electric power to the radio unit 6 (in step ST8c).

As mentioned above, in accordance with embodiment 4, if information indicating the airplane mode is stored in the internal memory 3 when the mobile communication terminal is powered on, the UI processing unit 2 enters a reception state in which it can receive a request to disable the wireless-communications function of the radio unit 6 and sets information indicating the disable mode to the internal memory 3 when receiving a request to disable the wireless-communications function, and the external input/output device control unit 5 supplies no electric power to the radio unit 6 if information indicating the disable mode is stored in the internal memory 3 when the mobile communication terminal is powered on. In other words, even if the wireless-communications function of the radio unit has been enabled before the user turns off the mobile communication terminal, the mobile communication terminal receives a request to disable the wireless-communications function at the same time that the mobile communication terminal is powered on and starts up with the wireless-communications function being placed in the disable mode when receiving a request to disable the wireless-communications function. Therefore, only when the user desires to disable the wireless-communications function, he or she can start the main body of the mobile communication terminal with the wireless-communications function of the radio unit being placed in the disable mode. As a result, the mobile communication terminal can disable the wireless-communications function of the radio unit in more appropriate cases.

Many widely different embodiments of the present invention may be constructed without departing from the spirit and scope of the present invention. It should be understood that the present invention is not limited to the specific embodiments described in the specification, except as defined in the appended claims.

What is claimed is:

1. A mobile communication terminal comprising:
a wireless communication unit having a wireless-communications function;
a setting input unit for receiving setting information about a setting which disables the wireless-communications function of said wireless communication unit;
a storage unit in which information indicating an operation mode of said wireless communication unit is stored;
a processing unit for storing information indicating a disable mode in which the wireless-communications function of said wireless communication unit is disabled into said storage unit when the setting information about the setting which disables the wireless-communications function of said wireless communication unit is inputted to said mobile communication terminal via said setting input unit; and
a disable control unit for controlling the wireless-communications function of said wireless communication unit so that the wireless-communications function does not work if the information indicating the disable mode is stored in said storage unit when said mobile communication terminal is powered on.

2. The mobile communication terminal according to claim 1, wherein the setting information about the setting which disables the wireless-communications function of said wireless communication unit is associated with turning on of a main body of said mobile communication terminal.

3. The mobile communication terminal according to claim 1, wherein the setting information about the setting which disables the wireless-communications function of said wireless communication unit is associated with turning off of a main body of said mobile communication terminal.

4. The mobile communication terminal according to claim 1, wherein said setting input unit receives information indicating a restriction mode in which the wireless-communications function of said wireless communication unit is to be disabled, and said processing unit stores the information indicating the restriction mode in said storage unit when the information indicating the restriction mode is inputted thereto via said setting input unit, and stores the information indicating the disable mode in said storage unit if the information indicating the restriction mode is stored in said storage unit before said disable control unit controls the wireless-communications function of said wireless communication unit when said mobile communication terminal is powered on.

5. The mobile communication terminal according to claim 1, wherein said setting input unit receives information indicating a restriction mode in which the wireless-communications function of said wireless communication unit is to be disabled, and receives a request to disable the wireless-communications function of said wireless communication unit if the information indicating the restriction mode is stored in said storage unit before said disable control unit controls the wireless-communications function of said wireless communication unit when said mobile communication terminal is powered on, and said processing unit stores the information indicating the disable mode in said storage unit when said setting input unit receives a request to disable the wireless-communications function of said wireless communication unit.
